(19) United States
(12) Patent Application Publication
(10) Pub. No.: US 2026/0338139 A1
(43) Pub. Date: Oct. 29, 2026

(54) INTERNAL COMBUSTION ENGINE AND A METHOD FOR OPERATING AN INTERNAL COMBUSTION ENGINE

(71) Applicant: INNIO Jenbacher GmbH & Co OG, Jenbach (AT)

(72) Inventors: Andreas Birgel, Innsbruck (AT); Johannes Huber, Kramsach (AT)

(21) Appl. No.: 19/660,211

(22) Filed: Apr. 27, 2026

(30) Foreign Application Priority Data
Apr. 28, 2025 (EP) 25172840

(51) Int. Cl. F02M 21/02; F02B 75/18; F02D 19/02; F02D 19/06; F02M 21/04; F02M 35/10

(52) U.S. Cl. CPC F02M 21/0245; F02B 75/18; F02D 19/023; F02D 19/0607; F02D 19/0644; F02D 19/0647; F02D 19/0665; F02D 19/0673; F02D 19/0684; F02M 21/0206; F02M 21/0212; F02M 21/0215; F02M 21/0221; F02M 21/023; F02M 21/04; F02M 35/10216; F02B 2075/1808

(57) ABSTRACT

Internal combustion engine, comprising at least two piston-cylinder units each providing a main combustion chamber, wherein an air-fuel mixture is combusted inside the main combustion chambers, an intake line for providing the main combustion chambers with the air-fuel mixture, at least one main fuel supply system provided at the intake line, wherein a combustible air-fuel mixture is provided by the main fuel supply system by mixing a fuel with an air feed in the intake line, at least two cylinder intakes, wherein each cylinder intake fluidically connects one of the main combustion chambers with the intake line, and an auxiliary fuel system configured to provide the main combustion chambers with additional fuel during a transient performance state or requirement, wherein the auxiliary fuel system comprises auxiliary fuel feeding lines, wherein the auxiliary fuel feeding lines branch into the cylinder intakes, such that the cylinder intakes of the main combustion chambers are fluidically coupled to at least one auxiliary fuel feeding line.

### CROSS-REFERENCE TO RELATED APPLICATION

This application claims priority to and benefit of European Patent Application No. EP 25172840.8, filed on Apr. 28, 2025, entitled “Internal Combustion Engine and a Method for Operating an Internal Combustion Engine”, which is herein incorporated by reference in its entirety for all purposes.

### FIELD OF THE INVENTION

The present disclosure concerns an internal combustion engine, a supply device for an internal combustion engine, the use of such a supply device in an internal combustion engine and a method for operating an internal combustion engine with the features described below.

### BACKGROUND

In the following, the state of the art will be outlined with making reference to specific embodiments, but the same issues and conditions apply generally to internal combustion engines.

Internal combustion engines known by the state of the art comprise:
at least two piston-cylinder units each providing a main combustion chamber, wherein an air-fuel mixture is combusted inside the combustion chambers,
an intake line for providing the combustion chambers with the air-fuel mixture,
at least one main fuel supply system provided at the intake line, wherein a combustible air-fuel mixture is provided by the main fuel supply system by mixing a fuel with an air feed in the intake line,
at least two cylinder intakes, wherein each cylinder intake fluidically connects one of the main combustion chambers with the intake line, and
an auxiliary fuel system configured to provide the main combustion chambers with additional fuel during a transient performance state or requirement.

Internal combustion engines according to the present disclosure are preferably provided as stationary internal combustion engines driving a generator to generate electrical energy. Such configurations are also known as Gensets or power generation plants.

These configurations are used, e.g., in microgrids or also called island grids. Such grids are local electrical grids with defined electrical boundaries, acting as a single and controllable entity. It is able to operate in grid-connected and off-grid modes. A stand-alone or isolated microgrid only operates off-the-grid and is not connected to a wider electric power system.

Another field of application is to stabilize public grids, wherein nowadays grids are confronted by greater main power fluctuations (caused by e.g. large applications of photovoltaics system, which power delivery can suddenly drop). These main power fluctuations can be smoothed by use of Gensets or power generation plants operated if the grid is in danger of cutting out.

In both cases, it is more and more important and essential to react to suddenly appearing power requests of the grid as soon as possible.

For reasons of efficiency, economy and ecology, it is state of the art to operate the internal combustion engine only if it is necessary or by an operation point having the lowest possible fuel consumption and/or emissions.

To react as soon as possible during transient performance state or requirement (the start of the internal combustion engine or increase of power output), it is known to provide an auxiliary fuel system to provide during transient performance state or requirements the internal combustion engine by an additional or more fuel.

Such a configuration is e.g. disclosed by U.S. Pat. No. 12,188,421 B2.

A disadvantage of such configuration is that such internal combustion engines still slowly react to power requirements.

### BRIEF DESCRIPTION

Therefore, an aspect of the present disclosure is to provide an internal combustion engine and a method for operating an internal combustion engine, wherein a higher agility and/or short reaction times during transient performance states or requirements can be realized.

This aspect is achieved by an internal combustion engine, a supply device for supplying an additional fuel into the cylinder intake of an internal combustion engine, the use of such a supply device being part of an internal combustion, a power generation plant with a fuel pipeline and such an internal combustion engine and a method for operating an internal combustion engine as described below.

Accordingly, an internal combustion engine comprises:
at least two piston-cylinder units each providing a main combustion chamber, wherein an air-fuel mixture is combusted inside the combustion chambers,
an intake line for providing the combustion chambers with the air-fuel mixture,
at least one main fuel supply system provided at the intake line, wherein a combustible air-fuel mixture is provided by the main fuel supply system by mixing a fuel with an air feed in the intake line,
at least two cylinder intakes, wherein each cylinder intake fluidically connects one of the main combustion chambers with the intake line, and
an auxiliary fuel system configured to provide the main combustion chambers with additional fuel during a transient performance state or requirement,
   wherein the auxiliary fuel system comprises auxiliary fuel feeding lines, wherein the auxiliary fuel feeding lines branch into the cylinder intakes, such that the cylinders intake of each main combustion chambers are fluidically coupled to at least one auxiliary fuel feeding line.

By providing an auxiliary fuel system having a direct connection in fluid communication sense to the cylinder intakes an additional fuel can be fed to the main combustion chamber with extremely short reaction times.

A larger reaction time normally present in the embodiments according to the prior art is causes by the time the additional fuel needs to pass through the intake system. This can be reduced or eliminated by supplying the additional fuel nearly directly into the main combustion chambers by providing auxiliary fuel feeding line of the auxiliary fuel system branching into the cylinder intake.

Therefore, during transient performance state or requirement the auxiliary fuel system can be used to rapidly feed additional fuel into the combustion chambers to increase the power delivery of the internal combustion engine in accordance with the transient performance state or requirement.

Compared to embodiments where the additional fuel is introduced only into the intake line, i.e., the common part of the fuel supply, tests conducted by the applicant have shown a surprising improvement in response time supplying the additional fuel into the cylinder intakes, i.e., the cylinder individual parts of the fuel supply.

Additionally, also a method for operating an internal combustion engine is provided, wherein during operation of the internal combustion engine an air-fuel mixture is supplied into at least two main combustion chambers provided by at least two piston-cylinder units via an intake line and cylinder intakes branching off the intake line, wherein each main combustion chamber is fluidically coupled to at least one cylinder intake, wherein during a transient performance state or requirement additional fuel is supplied directly via the cylinder intakes into the main combustion chambers.

It can be provided that the auxiliary fuel system comprises auxiliary fuel feeding lines for at least 50%, preferably 75%, particular preferred 90%, of the present cylinder intakes of the piston-cylinder units.

In other words, it can be provided that at least 50%, preferably 75%, particular preferred 90%, of all present main combustion chambers of the internal combustion engine are fluidically coupled via their cylinder intakes and auxiliary fuel feeding line provided for each of them with the auxiliary fuel system.

It can be provided that the auxiliary fuel system comprises auxiliary fuel feeding lines, wherein each auxiliary fuel feeding line branches into the cylinder intakes, such that each cylinder intake of each main combustion chamber is fluidically coupled to at least one auxiliary fuel feeding line.

To react during a transient performance state or requirement has to be understood within the present disclosure that a reaction is performed regarding a transient performance state or requirement. Such a reaction can also be initiated before the actual performance requirement occurs, at a time when the transient performance state or requirement is known.

That is, it is possible that a performance requirement to be expected in the future is known (e.g., if an additional consumer is connected to an microgrids, wherein the electrical power of the microgrid is provided by a generator coupled to the internal combustion engine), wherein the auxiliary fuel system starts to provide the main combustion engines shortly before the actual performance requirement occurs.

Already present internal combustion engines can be upgraded with an auxiliary fuel system according to the present disclosure.

All measures and features described in connection with the prior art can also be taken in connection with the present disclosure.

Advantageous embodiments of the disclosure are defined in the dependent claims.

It can be provided that the auxiliary fuel system fluidically connects the cylinder intakes with a pressurized fuel source.

The pressurized fuel source can be provided by at least one fuel tank, a fuel pipeline and/or high pressure fuel pipe.

It can be provided that the auxiliary fuel system comprises a central supply line fluidically coupled to an auxiliary fuel source, the central supply line of the auxiliary fuel system branching into the axillary fuel feeding lines fluidically coupled to one of the main combustion chambers.

The auxiliary fuel system can comprise a pressurizing device, preferably at least one pump and/or an auxiliary compressor, for pressurizing the additional fuel before feeding the additional fuel into the cylinder intakes.

It can be provided that the auxiliary fuel system comprises a pressure reduction device, preferably a pressure reduction valve, for reducing the pressure of the additional fuel before feeding the additional fuel into the cylinder intakes to a desired and/or consistent pressure level for the auxiliary fuel system.

Especially, if a high-pressure pipe is provided as fuel source for the additional fuel, a pressure reduction device can be used if the pressure of the delivered additional fuel from the high pressure pipe is above the boost pressure of the air-fuel mixture deliver by the main fuel supply system.

It can be provided that the fuel supplied by the main fuel supply system and the additional fuel supplied by the auxiliary fuel system is the same fuel or a different fuel.

The additional fuel supplied by the auxiliary fuel system can or could include as a main part natural gas, hydrogen or propane.

It can be provided that the auxiliary fuel system comprises at least one control valve, preferably a control valve in each axillary fuel feeding line, for controlling the fuel amount supplied during transient performance state or requirement.

At least one compressor and/or intercooler can be arranged at the intake line, preferably wherein the at least one compressor and/or intercooler is arranged downstream in flow direction of the air-fuel mixture of the main fuel supply system.

It can be provided that the at least one compressor belongs to a turbocharger comprising at least one exhaust turbine, wherein the at least one exhaust turbine is mechanically coupled with the at least one compressor and configured to drive the compressor.

The turbocharger can be provided as an arrangement of turbine-compressor-units and be provided, e.g., as a two stage turbo charger and/or bi-turbo charger.

It can be provided that the main fuel supply system comprises a fuel mixer arranged at the intake line, mixing fuel of a fuel source with an air feed in the intake line.

Protection is also sought for a power generation plant with a fuel pipeline and an internal combustion engine according to the present disclosure, wherein the fuel pipeline is configured to supply the additional fuel to the auxiliary fuel system and preferably to the main fuel supply system.

Furthermore, protection is sought for a supply device for supplying an additional fuel into the cylinder intake of an internal combustion engine, preferably a supply device being part of an auxiliary fuel system according to the present disclosure, wherein the supply device comprises an cylindrical shaped base body to be arranged projecting into the cylinder intake of an main combustion chamber, wherein the cylindrical shaped base body comprises a plurality of radial openings, preferably bores, for introducing additional fuel into the cylinder intake.

Such a supply device provides a simple and efficient way to directly supply the additional fuel into the cylinder lines. It provides a possibility to update already existing systems by an auxiliary fuel system corresponding to the present disclosure, wherein the cylinder lines can be provided by bores in which the supply device can be mounted, extending into the cylinder lines, wherein via the radial openings of the cylindrical base body of the supply device additional fuel can be directly be fed into the cylinder lines and therefore into the main combustion chambers.

Protection is also sought for the use of a supply device according to the present disclosure being part of an auxiliary fuel system in an internal combustion engine.

It can be provided that during transient performance state or requirement the additional fuel amount is 5% to 30% of the overall fuel amount supplied to the supplied into each main combustion chamber of the internal combustion engine.

The above identified ranges of supplied additional fuel have to be seen as percentages of the overall fuel volume supplied to main combustion chambers.

### BRIEF DESCRIPTION OF THE DRAWINGS

Further details and advantages are apparent from the accompanying figures and the following description of the drawings. The figures show:

FIG. 1 illustrates a first embodiment of an internal combustion engine,

FIG. 2 illustrates a second embodiment of an internal combustion engine,

FIG. 3 illustrates a third embodiment of an internal combustion engine,

FIG. 4 illustrates a fourth embodiment of an internal combustion engine, and

FIG. 5 illustrates a cross section of a piston-cylinder unit of an internal combustion engine, and

FIG. 6a-6c illustrate a method for providing additional fuel during a transient performance state or requirement.

### DETAILED DESCRIPTION

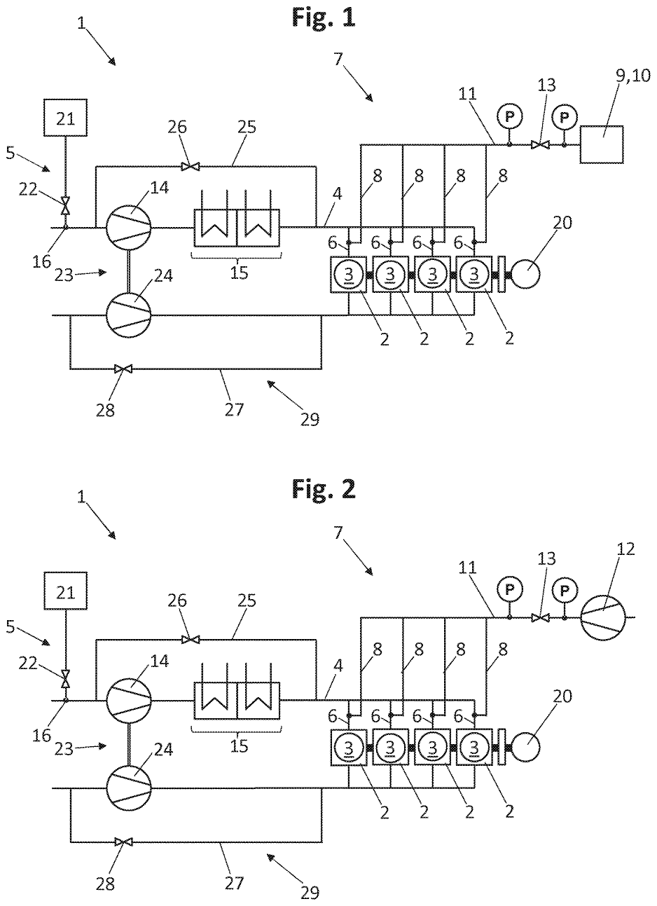

FIG. 1 illustrates a first embodiment of an internal combustion engine 1 according to the present disclosure.

This internal combustion engine 1 comprises four cylinder-piston units 2 providing main combustion chambers 3 in which an air-fuel mixture is combusted.

Embodiments of the invention are, of course, not restricted to four or eight cylinder-piston units 2 used in the Figures, which serve only as an example. Embodiments of the invention can be used on an internal combustion engine 1 for two or more cylinder-piston units 2.

The air-fuel mixture supplied to the main combustion chambers 3 of the cylinder-piston units 2 is mixed at the schematically shown fuel mixer 16 at the intake line 4.

The fuel mixer 16 is part of the main fuel supply system 5 and mixes an air feed in the intake line 4 with fuel provided by the main fuel source 21 (e.g., a gas or fuel pipeline providing hydrogen or natural gas).

An amount of fuel mixed to the air feed if the intake line 4 can be regulated by the fuel valve 22, wherein the lambda value of the air-fuel mixture combusted in the main combustion chambers 3 during steady state operation of the internal combustion engine can be regulated.

The fuel mixer 16 is provided in the intake line 4 upstream of the compressor 14.

By use of the compressor 14 of the turbocharger 23, the air-fuel mixture is pressurized and cooled after compression by the compressor 14 in an intercooler 15.

The intercooler 15 is provided by a two stage heat exchange, wherein in flow direction the air-fuel mixture is firstly passed through a high temperature heat exchanger and afterward through a low temperature heat exchanger.

The air of the air-fuel mixture compressed by the compressor 14 is aspirated via the air filter (not shown in this specific figure) from the environment of the internal combustion engine 1.

The compressor 14 of the turbocharger 23 is driven by a mechanically connected exhaust turbine 24, which is arranged in the exhaust system 29 and driven by exhaust gases resulting from the combustion inside the piston-cylinder units 2.

The intercooler 15 and the compressor 14 can be bypassed by an intake bypass line 2 with a compressor bypass valve 28, wherein a boost pressure can be adjusted by this compressor bypass valve 28.

By changing the boost pressure, it is possible to vary the filling of piston-cylinder units 2.

The intake line 4 branches into the cylinder intakes 6, wherein each main combustion chamber 2 is fluidically coupled to the intake line 4 and fed with air-fuel mixture by at least one cylinder intake 6.

An exhaust system 29 for discharging an exhaust gas from the cylinder-piston units 2 after combustion is provided being connected to each cylinder-piston unit 2.

In addition, the turbocharger 23 has an exhaust turbine 24 being arranged at the exhaust system 29.

The exhaust turbine 24 can be bypassed by an exhaust bypass line 27 along with the turbine bypass valve 28.

By means of this turbine bypass valve 28, an exhaust backpressure can be set which acts on the main combustion chambers 3 of the piston-cylinder units 2.

The piston of the piston-cylinder units 2 is mechanically connected via connecting rods with a crankshaft (for reasons of clarity not shown), wherein the crankshaft is rotatably arranged inside the crankcase.

The crankshaft of the internal combustion engine 1 of this embodiment is mechanically coupled to an electrical generator 20, wherein the generator 20 is driven by the internal combustion engine 1 to generate electrical energy which can be delivered into a grid.

In this case, it can be necessary to react as soon as possible to variations of the grid within suddenly appearing power requests to the internal combustion engine 1. Such transient performance states or requirements of the internal combustion engine 1 can affect, e.g., a power increase or the start of the internal combustion engine 1.

For these operation modes (transient performance states or requirements), an auxiliary fuel system 7 is provided and configured to provide the main combustion chambers 3 with additional fuel during the transient performance state or requirement.

The auxiliary fuel system 7 comprises auxiliary fuel feeding lines 8, wherein each auxiliary fuel feeding line 8 branches into the cylinder intakes 6, such that each cylinder intake 6 of each main combustion chamber 3 is fluidically coupled to at least one auxiliary fuel feeding line 8.

The auxiliary fuel system 7 fluidically connects the cylinder intakes 6 with a pressurized fuel source 9, wherein in this first embodiment the fuel source 9 is provided by a fuel tank 10.

A central supply line 11 of the auxiliary fuel system 7 is fluidically coupled to an auxiliary fuel source 9, the central supply line 11 branching into the four axillary fuel feeding lines 8 each fluidically coupled to one of the main combustion chambers 3.

A control valve 13 of the auxiliary fuel system 7 comprises at least one, preferably a control valve for controlling the additional fuel amount supplied during transient performance state or requirement is provided at the central supply line 11 of the auxiliary fuel system 7.

FIG. 2 discloses a second embodiment of an internal combustion engine 1 according to the present disclosure, wherein in contrast to the first embodiment the fuel source 9 of additional fuel of the auxiliary fuel system 7 is provided by a fuel pipe of a gas pipe.

To provide this fuel of the gas pipe with a necessary pressure to be fed into the intake system of the internal combustion engine the auxiliary fuel system 7 is provided by an auxiliary compressor 12.

The remaining characteristics essentially correspond with the characteristics disclosed by the first embodiment shown by FIG. 1.

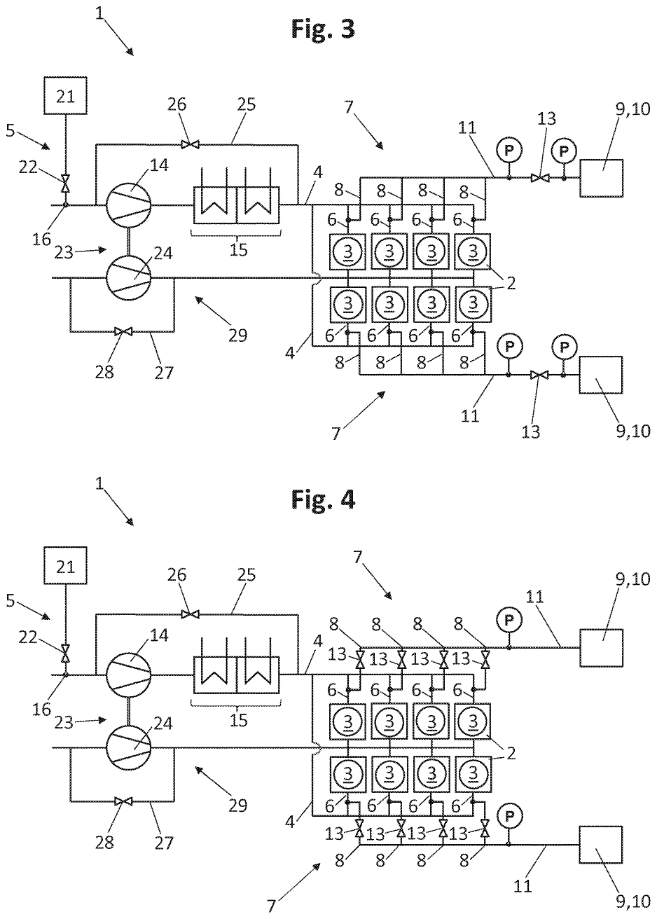

FIG. 3 discloses a third embodiment of an internal combustion engine 1 according to the present disclosure, wherein in contrast to the first embodiment of FIG. 1 the internal combustion engine 1 comprises two cylinder banks each comprising four piston-cylinder units 2.

Both cylinder banks are supplied by the same main fuel supply system 5, but each cylinder bank is provided by a separate auxiliary fuel system 7.

The auxiliary fuel system 7 are identically built up and correspond to the embodiment of FIG. 1.

The remaining characteristics essentially correspond with the characteristics disclosed by the first embodiment shown by FIG. 1.

The remaining characteristics essentially correspond with the characteristics disclosed by the first embodiment shown by FIG. 3.

FIG. 4 discloses a fourth embodiment of an internal combustion engine 1 according to the present disclosure, wherein in contrast to the third embodiment of FIG. 3 each auxiliary fuel feeding line 8 comprises a control valve 13, wherein the amount of auxiliary fuel supplied to the main combustion chambers 3 can be controlled individual for each piston-cylinder unit 2 and therefore each main combustion chamber 3.

The remaining characteristics essentially correspond with the characteristics disclosed by the first embodiment shown by FIG. 3.

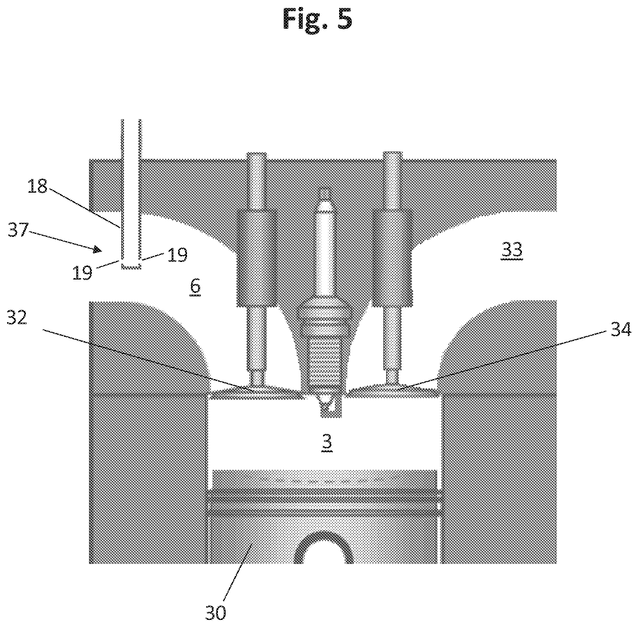

FIG. 5 discloses a cross section of a piston-cylinder unit 2 of an internal combustion engine 1, wherein a piston 30 is arranged in a cylinder 31, whereby a main combustion chamber 3 is formed between the piston 30 and the cylinder 31.

A cylinder intake 6 can be fluidically connected and disconnected by an intake valve 32 and a cylinder outlet 33 by an exhaust valve 34 with the main combustion chamber 3.

A supply device 17 for supplying additional fuel into the cylinder intake 6 of an internal combustion engine 1 is provided extending into the cylinder intake 6.

The supply device 17 comprises a cylindrical shaped base body 18 to be arranged projecting into the cylinder intake 4

The cylindrical shaped base body 18 comprises a plurality of radial openings 19, preferably bores, for introducing additional fuel from the auxiliary fuel feeding lines into the cylinder intake 4.

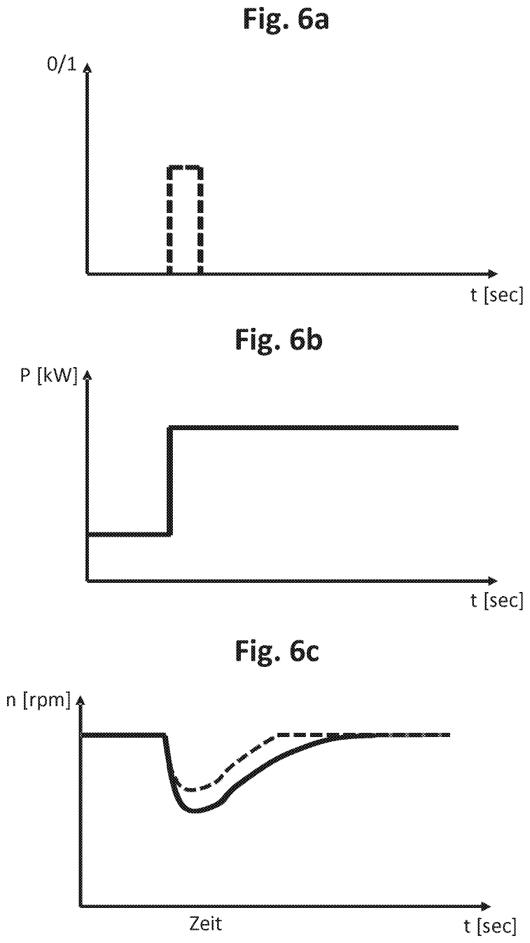

FIG. 6a to FIG. 6c show a method for providing additional fuel to the main combustion chamber 3 during a transient performance state or requirement according to the precent disclosure compared to an embodiment known by the state of the art.

Therefore, FIG. 6b illustrates a suddenly appearing power requirement delivered to the internal combustion engine 1, as can be seen by the increase of the power p [kw] requirement along the time-axis t [sec].

If an internal combustion engine 1 would be operated as known by the state of the art, the rotational speed would significantly collapse as illustrated by be solid line of FIG. 6c, before the control of the air-fuel mixture is adapted accordingly to provide the main combustion chamber 3 with an increased fuel amount to return to the desired rotational speed of the internal combustion engine 1.

This collapse of the rotational speed during transient performance state or requirement is caused by the reaction time of a control identifying a transient performance state or requirement and taking counterreactions.

But furthermore, this collapse of the rotational speed is also caused by the fact that the increase of the fuel delivered to the main combustion chambers 3 does have to be fed through the whole intake system which does take time.

The present disclosure therefore activates the control valve 13 of the auxiliary fuel system 7 (as indicated by the dotted line of FIG. 6a)—in other words: wherein the control valve opens and additional fuel is fed into the auxiliary fuel feeding lines 8 via the cylinder intakes 6 directly into the main combustion chambers 3.

Therefore, by use of an auxiliary fuel system 7 according to the present disclosure the time delay of the increase fuel amount delivered to the main combustion chambers 3 can be significantly reduced, wherein a collapse of the rotational speed during transient performance state or requirement can significantly reduced and an agility of the internal combustion engine 1 can be increased, as shown by the dotted line of FIG. 6c (illustrating the rotational speed of an internal combustion engine 1 operated accordingly to a method of the present disclosure.

### USED REFERENCE SIGNS

1 internal combustion engine
2 piston-cylinder unit
3 main combustion chamber
4 intake line
5 main fuel supply system
6 cylinder intakes
7 auxiliary fuel system
8 auxiliary fuel feeding lines
9 fuel source
10 fuel tank
11 central supply line
12 auxiliary compressor
13 control valve
14 compressor
15 intercooler
16 fuel mixer
17 supply device
18 base body of the supply device
19 radial openings
20 electrical generator
21 main fuel source
22 fuel valve
23 turbocharger
24 exhaust turbine
25 intake bypass line
26 compressor bypass valve
27 exhaust bypass line
28 turbine bypass valve
29 exhaust system
30 piston
31 cylinder
32 intake valve
33 cylinder outlet
34 exhaust valve

1. A system, comprising:
an internal combustion engine, comprising
at least two piston-cylinder units each providing a main combustion chamber, wherein an air-fuel mixture is combusted inside the main combustion chambers;
an intake line for providing the main combustion chambers with the air-fuel mixture;
at least one main fuel supply system provided at the intake line, wherein a combustible air-fuel mixture is provided by the main fuel supply system by mixing a fuel with an air feed in the intake line;
at least two cylinder intakes, wherein each cylinder intake fluidically connects one of the main combustion chambers with the intake line; and
an auxiliary fuel system configured to provide the main combustion chambers with additional fuel during a transient performance state or requirement, wherein the auxiliary fuel system comprises auxiliary fuel feeding lines, wherein the auxiliary fuel feeding lines branch into the cylinder intakes, such that the cylinder intakes of the main combustion chambers are fluidically coupled to at least one auxiliary fuel feeding line.

2. The system of claim 1, wherein the auxiliary fuel system fluidically connects the cylinder intakes with a pressurized fuel source.

3. The system of claim 2, wherein the pressurized fuel source is provided by at least one fuel tank, a fuel pipeline and/or high pressure fuel pipe.

4. The system of claim 1, wherein the auxiliary fuel system comprises a central supply line fluidically coupled to an auxiliary fuel source, the central supply line of the auxiliary fuel system branching into the auxiliary fuel feeding lines fluidically coupled to one of the main combustion chambers.

5. The system of claim 1, wherein the auxiliary fuel system comprises a pressurizing device comprising at least one pump and/or an auxiliary compressor, and the pressurizing device is configured to pressurize the additional fuel before feeding the additional fuel into the cylinder intakes.

6. The system of claim 1, wherein the fuel supplied by the main fuel supply system and the additional fuel supplied by the auxiliary fuel system is the same fuel or a different fuel.

7. The system of claim 1, wherein the additional fuel supplied by the auxiliary fuel system is or comprises as a main part natural gas, hydrogen or propane.

8. The system of claim 1, wherein the auxiliary fuel system comprises at least one control valve, including a control valve in each auxiliary fuel feeding line, configured to control the fuel amount supplied during transient performance state or requirement.

9. The system of claim 1, wherein at least one compressor and/or intercooler is arranged at the intake line, wherein the at least one compressor and/or intercooler is arranged downstream in flow direction of the air-fuel mixture of the main fuel supply system.

10. The system of claim 1, wherein the main fuel supply system comprises a fuel mixer arranged at the intake line, and the fuel mixer is configured to mix fuel of a fuel source with an air feed in the intake line.

11. The system of claim 1, comprising a power generation plant with a fuel pipeline and the internal combustion engine, wherein the fuel pipeline is configured to supply the additional fuel to the auxiliary fuel system and to the main fuel supply system.

12. The system of claim 1, wherein the auxiliary fuel system comprises a supply device configured to supply the additional fuel into the cylinder intake of the internal combustion engine, wherein the supply device comprises an cylindrical shaped base body to be arranged projecting into the cylinder intake of the main combustion chamber, wherein the cylindrical shaped base body comprises a plurality of radial openings or bores configured to introduce the additional fuel into the cylinder intake.

13. A method of using the supply device of claim 12 being part of the auxiliary fuel system in the internal combustion engine.

14. A method of operating the internal combustion engine of claim 10, wherein during operation of the internal combustion engine the air-fuel mixture is supplied into at least two main combustion chambers provided by at least two piston-cylinder units via the intake line and cylinder intakes branching off the intake line, wherein each main combustion chamber is fluidically coupled to at least one cylinder intake, wherein during the transient performance state or requirement the additional fuel is supplied directly via the cylinder intakes into the main combustion chambers.

15. The method of claim 14, wherein during the transient performance state or requirement the additional fuel amount is 2% to 10% of the overall fuel amount supplied to the supplied into each main combustion chamber of the internal combustion engine.

16. A system, comprising:
an auxiliary fuel system configured to provide one or more main combustion chambers with additional fuel during a transient performance state or requirement, wherein the auxiliary fuel system comprises one or more auxiliary fuel feeding lines, wherein the one or more auxiliary fuel feeding lines branch into one or more cylinder intakes, such that the one or more cylinder intakes of the one or more main combustion chambers are fluidically coupled to at least one auxiliary fuel feeding line.

17. The system of claim 16, wherein the auxiliary fuel system comprises a supply device configured to supply the additional fuel into the one or more cylinder intakes of the internal combustion engine, wherein the supply device comprises an cylindrical shaped base body to be arranged projecting into the one or more cylinder intakes of the main combustion chamber, wherein the cylindrical shaped base body comprises a plurality of radial openings or bores configured to introduce the additional fuel into the one or more cylinder intakes.

18. The system of claim 17, further comprising the one or more cylinder intakes having the supply device.

19. A method, comprising:
providing, via an auxiliary fuel system, additional fuel to one or more main combustion chambers during a transient performance state or requirement, wherein the auxiliary fuel system comprises one or more auxiliary fuel feeding lines, wherein the one or more auxiliary fuel feeding lines branch into one or more cylinder intakes, such that the one or more cylinder intakes of the one or more main combustion chambers are fluidically coupled to at least one auxiliary fuel feeding line.

20. The method of claim 19, wherein providing the additional fuel comprises supplying, via a supply device, the additional fuel into the one or more cylinder intakes of the internal combustion engine, wherein the supply device comprises an cylindrical shaped base body to be arranged projecting into the one or more cylinder intakes of the main combustion chamber, wherein the cylindrical shaped base body comprises a plurality of radial openings or bores configured to introduce the additional fuel into the one or more cylinder intakes.
